(19) United States
(12) Patent Application Publication
(10) Pub. No.: US 2006/0175312 A1
(43) Pub. Date: Aug. 10, 2006

(54) Method and system for production of dynamic laser-induced images inside gaseous medium

(76) Inventor: Igor Troitski, Henderson, NV (US)

Correspondence Address: IGOR TROITSKI, 853 ARROWHEAD TRAIL, HENDERSON, NV, 89015, US

(21) Appl. No.: 11/053,983

(22) Filed: Feb. 10, 2005

(51) Int. Cl. B23K 26/00

(52) U.S. Cl. 219/121.85

(57) ABSTRACT

One or more embodiments of the invention comprise a method for creating breakdown sparks of needed brightness, sizes and duration by controlling pulse energy, pulse width, pulse duration, wavelength, temporal shape and space structure of laser radiation. Method for transformation of a dynamic image into succession of points arrangements for gaseous medium, at which breakdown sparks are produced, is disclosed. One or more embodiments of the invention comprise a method and a system for production of dynamic laser-induced images inside gaseous medium. These images are configurations of sparks which are changed by controlling the points of the gaseous medium at which the laser breakdowns are generated.

### FIELD OF THE INVENTION

The present invention relates to methods for producing laser-induced images inside transparent medium by using pulsed laser radiation.

### BACKGROUND OF THE INVENTION

A number of techniques for creation of images inside solid transparent substrates by using pulsed laser radiation are well known.

The publication disclosing such techniques is the Russian invention # 321422 to Agadjanov et. al., published on Nov. 16, 1970 (#140454529-33). The invention concerns a method of manufacturing decorative products inside a transparent material by changing the material structure by laser radiation. As disclosed, by moving a material relative to a focused laser beam, it is possible to create a drawing inside the material.

U.S. Pat. No. 4,092,518 to Merard discloses a method for decorating transparent plastic articles. This technique is carried out by directing a pulsed laser beam into the body of an article by successively focusing the laser beam in different regions within the body of the article. The pulse energy and duration is selected based upon the desired extent of the resulting decorative pattern. The effect of the laser is a number of three dimensional “macro-destruction” (fissures in the material of the article) appearing as fanned-out cracks. The pattern of the cracks produced in the article is controlled by changing the depth of the laser beam focus along the length of the article. Preferably, the article is in the form of a cylinder, and the cracks are shaped predominantly as saucer-like formations of different size arranged randomly around the focal point of the optical system guiding a laser beam. The device used to carry out this technique is preferably a multi-mode solid-state, free-running pulse laser used in conjunction with a convergent lens having a focal length from 100 to 200 mm.

U.S. Pat. No. 4,843,207 to Urbanek et al. discloses a method of creating controlled decorations on the surface of a hollow symmetrical transparent article. This technique is preferably carried out on glass. The glass is preconditioned with a coating on the outer surface of the glass being approximately 1.2 mm thick and made of a material having at least 75% absorption of laser radiation. The technique is also carried out using a laser having a wave of length of 0.5 to 2 microns acting upon the external coating through the wall of the cylindrical glass article. The laser beam moves so that it is focused on the surface of the cylinder, and moves about the axis of symmetry of the cylinder to irradiate the aforementioned surface coating. As a result, the irradiated portions of the surface coating go through a phase change and a pattern is formed.

U.S. Pat. No. 5,206,496 to Clement et al. discloses a method and apparatus for providing in a transparent material, such as glass or plastic, a mark which is visible to the naked eye or which may be “seen” by optical instruments operating at an appropriate wavelength. The Clement et al. Patent describes a method and apparatus for producing a subsurface marking which is produced in a body such as bottle, by directing into the body a high energy density beam and bringing the beam to focus at a location spaced from the surface, so as to cause localized ionization of the material. In the preferred embodiment the apparatus includes a laser as the high energy density beam source. The laser may be a Nd-YAG laser that emits a pulsed beam of laser radiation with a wavelength of 1064 nm. The pulsed beam is incident upon a first mirror that directs the beam through a beam expander and a beam combiner to a second mirror. A second source of laser radiation in the form of a low power He—Ne laser emits a secondary beam of visible laser radiation with a wavelength of 638 m. The secondary beam impinges upon the beam combiner where it is reflected toward the second reflecting surface coincident with the pulsed beam of laser radiation from the Nd-YAG laser. The combined coincident beams are reflected at the reflecting surface via reflecting two other surfaces to a pair of movable mirrors for controlling movement of the beam. The beam then passes through a lens assembly into the body to be marked.

U.S. Pat. No. 5,575,936 to Goldfarb discloses a process and apparatus where a focused laser beam causes local destruction within a solid article, without affecting the surface thereof. The apparatus for etching an image within a solid article includes a laser focused to a focal point within the article. The position of the article with respect to the focal point is varied. Control means, coupled to the laser, and positioning means are provided for firing the laser so that a local disruption occurs within the article to form the image within the article.

U.S. Pat. No. 5,637,244 to Erokhin discloses a technique which depends on a particular optical system including a diffraction limited Q-switched laser (preferably a solid-state single-mode TEM₀₀) aimed into a defocusing lens having a variable focal length to control the light impinging on a subsequent focusing lens that refocuses the laser beam onto the transparent article being etched. The laser power level, operation of the defocusing lens, and the movement of the transparent article being etched are all controlled by a computer. The computer operates to reproduce a pre-programmed three-dimensional image inside the transparent article being etched. In the computer memory, the image is presented as arrays of picture elements on various parallel planes. The optical system is controlled to reproduce the stored arrays of picture elements inside the transparent material. A method for forming a predetermined half-tone image is disclosed. Accordance to the method, microdestructions of a first size are created to form a first portion of the image and microdestruction of a second size different from the first size are created to form a second portion of the image. Different sizes of microdestructions are created by changing the laser beam focusing sharpness and the radiation power thereof before each shot.

U.S. Pat. No. 5,656,186 to Mourou, et al. discloses method for laser induced breakdown of a material with a pulsed laser beam where the material is characterized by a relationship of fluence breakdown threshold versus laser beam pulse width that exhibits an abrupt and rapid.

U.S. Pat. No. 5,886,318 to A. Vasiliev and B. Goldfarb discloses a method for laser-assisted image formation in transparent specimens which consists in establishing a laser beam having different angular divergence values in two mutually square planes. An angle between the plane with a maximum laser beam angular divergence and the surface of the image portion being formed is changed to suit the required contrast of an image.

U.S. Pat. No. 6,087,617 to Troitski et al. discloses a computer graphic system for producing an image inside optically transparent material. An image reproducible inside optically transparent material by the system is defined by potential etch points, in which the breakdowns required to create the image in the selected optically transparent material are possible. The potential etch points are generated based on the characteristics of the selected optically transparent material. If the number of the potential etch points exceeds a predetermined number, the system carries out an optimization routine that allows the number of the generated etch points to be reduced based on their size. To prevent the distortion of the reproduced image due to the refraction of the optically transparent material, the coordinates of the generated etch points are adjusted to correct their positions along a selected laser beam direction.

U.S. Pat. No. 6,333,485 to Haight, et al. discloses method for minimizing sample damage during the ablation of material using a focused ultra short pulsed beam. In one aspect the invention provides a method for laser induced breakdown of a material with a pulsed laser beam where the material is characterized by a relationship of flounce breakdown threshold versus laser beam pulse width that exhibits an abrupt, rapid, and distinct change or at least a clearly detectable and distinct change in slope at a predetermined laser pulse width value.

U.S. Pat. No. 6,333,486 to Troitski discloses a method for production of etch points inside transparent material, which have the same size but different brightness. Laser-induced damages produced by this method provide the reproduction of image gradation without changing of their spatial resolution.

U.S. Pat. No. 6,399,914 to Troitski discloses a method for producing laser-induced images inside the special transparent material containing special kinds of impurities, which decrease the damage threshold of the material that provides creation of small and without star structure laser-induced damages.

U.S. Pat. No. 6,417,485 to Troitski discloses a method and laser system for producing laser-induced damages inside transparent materials by controlling breakdown process development. At the beginning an applied laser radiation level just exceeds an energy threshold for creating a plasma condition inside the transparent material, and thereafter the energy level of the applied laser radiation is just maintain the plasma condition and is applied before the plasma condition extinguished, but after a shock wave associated therewith has passed.

U.S. Pat. No. 6,426,480 to Troitski discloses a method and system for producing single layer laser-induced damage portrait inside transparent material which are based on generation of small smoothed etch points of determined sizes and on control of their brightness without variation of their determined sizes.

U.S. Pat. No. 6,490,299 to Raevski et al. discloses method and laser system producing high quality laser-induced images inside transparent materials by using specific laser radiation generated by serial combination of both generation regims: a Q-switched mode and a free-running mode.

U.S. Pat. No. 6,509,548 to Troitski discloses a method and apparatus for producing high-resolution laser-induced damage images inside transparent materials by small etch points. The method is based on generation of the initial electron density in the relatively large volum, creation of the breakdown at a small part of the said volume and control of the energy amount enclosed inside the plasma.

U.S. Pat. No. 6,596,967 to Miesak discloses a laser based etching device, which modifies the optical properties of an object by using a light beam from a light source that is focused at a first focal point within the object to optically change a first location within the object at the first focal point.

U.S. Pat. No. 6,605,797 to Troitski discloses laser-computer graphics systems for producing images such as portraits and 3-D sculptures formed from laser light created etch points inside an optically transparent materials. The produced image has a high resolution like a computer graphic image from which it is derived, little fluctuation in gray shades, and has no discernable point structure.

U.S. Pat. No. 6,630,644 to Troitski et al. discloses a method for creating arrangement of damages for producing 3D laser-induced damage portraits with the space resolution, which is equal to the appropriate computer 3D model.

U.S. Pat. No. 6,664,501 to Troitski discloses a method for creating laser-induced color images within three-dimensional transparent material.

U.S. Pat. No. 6,670,576 to Troitski et al. discloses a method for producing laser-induced images inside transparent materials containing laser-induced color centers and laser-induced damages.

U.S. Pat. No. 6,720,521 to Troitski discloses a method for generating an area of laser-induced damage inside a transparent material by controlling a special structure of a laser radiation.

U.S. Pat. No. 6,720,523 to Troitski discloses a method for production of laser-induced images inside transparent material, when complete image information is lacking before production and is supplemented only during production.

U.S. Pat. No. 6,727,460 to Troitski discloses a system for high-speed production of high quality laser-induced damage images inside transparent materials. The system produces the said images by the combination of an electro-optical deflector and means for moving the article or focusing optical system.

U.S. Pat. No. 6,734,389 to Troitski discloses an apparatus for producing high quality laser-induced images inside optically transparent material by controlling breakdown process development and space structure of laser radiation.

U.S. Pat. No. 6,740,846 to Troitski et al. discloses a method for producing 3D laser-induced portrait by using several 2D regular portraits.

U.S. Pat. No. 6,768,080 to Troitski discloses a method for production of laser-induced images which are looked like iridescent images laying out white light incident upon them. These images are created by generation of laser-induced damages of special space form.

U.S. Pat. No. 6,768,081 to Troitski discloses a method and apparatus for producing high quality laser-induced images inside optically transparent material by using material processing made before and after image creation.

All patents mentioned above disclose methods and systems for creation of laser-induced images inside solid transparent materials. Most of these methods and systems are based on the breakdown which is produced by focusing laser beam inside solid transparent material. The breakdown creates a small damage of the transparent material which is visible because it scatters the exterior light. Thus, laser-induced images (more correctly, laser-induced damage images) produced by the systems disclosed in patents mentioned above are pluralities of damages inside a solid transparent material created by a pulsed laser beam, which is periodically focused at predetermined points of the material. These laser-induced damage images are stationary in time, they are created for ever and can be destroyed by destruction of the transparent material only.

However, the breakdown, creating a material damage, simultaneously, creates a bright flash of white light, the appearance of which leads to the term “spark”. The spark is accompanied by production of charged particles, absorption of the laser light, and reradiation of light from the spark. It is very important to notice that as a result of the breakdown phenomenon, a spark at the focus of laser beam can be produced in any transparent material including gases that are usually completely transparent to light, such as air and the noble gases. The breakdown sparks exist during very short time period but they can have very high brightness and therefore are visible with the naked eye. Consequently, it is possible to create instantaneous images inside gaseous medium by focusing the laser beam at predetermining points of the medium and generating breakdowns at those points. The illusion of motion could be created by viewing a rapid sequence of slightly different instantaneous laser-induced images. An image which can be represented by similar sequence of laser-induced images will be called the dynamic laser-induced image. The present invention discloses the method and the system for creation of such dynamic laser-induced images inside gaseous medium by using breakdown sparks.

### SUMMARY OF THE INVENTION

The principal task of the present invention is to provide a method for production of dynamic laser-induced images which are inside gaseous medium and which are visible without exterior illumination.

One or more embodiments of the invention comprise a method for generation of breakdown sparks of the predetermined parameters needed for production of high quality laser—induced images inside gaseous medium.

Another embodiment of the invention comprises a method for production of dynamic laser-induced images inside gaseous medium by focusing laser beam at the predetermining points of the medium and generating breakdown sparks at the points of this medium.

One or more embodiments of the invention comprise a method for control of spark production during the creation of dynamic laser-induced images inside gaseous medium.

Another embodiment of the invention comprises a system for production of dynamic laser-induced images with special light parameters by using specific gaseous medium.

### DESCRIPTION OF THE DRAWINGS

FIG. 1 shows a photo of an air breakdown spark produced by single mode second harmonic of Nd-YAG laser radiation focused by lens with short focal length (35 mm).

FIG. 2 shows a photo of an air breakdown spark produced by single mode second harmonic of Nd-YAG laser radiation focused by lens with short focal length (35 mm). The spark of this Figure was produced by laser radiation with pulse energy which is smaller than the energy used for production of the spark of FIG. 1.

FIG. 3 illustrates in block-diagram form a system for production of dynamic laser-induced images inside gaseous medium. Computer graphic system transforms an image into point arrangements and transfers this information to the control system, which controls the laser system, and systems for directing and focusing laser radiation at the predetermined points of the gaseous medium. Simultaneously, the control system transfers information into gaseous medium system which creates and controls gaseous

### DETAILED DESCRIPTION OF THE INVENTION

The invention comprises a method and a system for production of dynamic laser-induced images inside gaseous medium by using sparks generated by the laser breakdown.

The principal concepts of the invention are based on the following pieces of evidence of laser-induced breakdown in gases:
1) The laser-induced breakdown is generated at the focal area of pulsed laser radiation.
2) The breakdown occurs only after threshold irradiance is achieved. Below the threshold value, virtually no effects are observed.
3) Simultaneously with the breakdown occurs a bright flash of white light, the appearance of which leads to the term “spark”.
4) The spark is accompanied by production of charged particles, absorption of the laser light, and reradiation of light from the spark.
5) The breakdown in gases has two general stages: (1) the production of the initial ionization, and (2) the subsequent cascade by which the ionization grows and a spark is observed.
6) For a small focal volume, higher laser intensity is required to produce breakdown within the same time. This is taken as evidence of losses in the cascade process. As the focal volume becomes small, losses, either by diffusion of the electrons out of the focal region or by radiation, limit the buildup. The cascade processes more rapidly at a given irradiance with a larger focal volume.
7) The breakdown threshold decreases as a function of increasing pressure.
8) The value of breakdown threshold depends on the wavelength of laser radiation, for example, for first, second, third, and fourth harmonics of Nd-YAG laser (1.06; 0.53; 0.353, and 0.265μ) the relative thresholds for breakdown of air are in the ratio 5.2: 6.2: 5.2: 3.4.
9) The presence of easily ionized impurities in any gas, even in small concentration, decreases the breakdown threshold.
10) The brightness and geometry (shape) of the sparks are functions of many variables, including the characteristics of laser radiation, gaseous media and optical devises focusing the radiation.
11) The breakdown sparks exist during a very short time period but they can have very high brightness and therefore are visible with the naked eye.

Development of the spark has been studied in detail by many different techniques, including streak photography, shadow photography, high-speed framing photography, microwave investigations, holography, and schlieren photography using a mode-locked laser to give high time resolution (John F. Ready, Effects of High-Power Laser Radiation, Academic Press, New York, 1971). A general feature of the spark development is the asymmetric growth. The spark spreads backwards, toward the laser. The growth fills the angular cone defined by the laser beam converging toward a focus. Initially, bright, fast-moving plasmas are generated. After the end of the laser pulse, the heated gas expands more slowly and persists for some time. John F. Ready shows schematic drawing from photograph of air breakdown and streak photographs of laser-generated spark in atmospheric pressure air (John F. Ready, Effects of High-Power Laser Radiation, Academic Press, New York, 1971), from which we can conclude that the spark has a complicated shape which can be changed from one pulse to another.

However, since laser-induced images created inside gases are visible because of the light of the breakdown sparks, the quality of these images depends on the shapes and sizes of these sparks. For example, high resolution can be provided by identical sparks of small sizes and it is very important to have the opportunity to control spark parameters including brightness, sizes and duration.

One or more embodiments of the invention comprise a method for controlling spark sizes and brightness by controlling pulse energy of laser radiation, so that laser radiation of smaller pulse energy is used for creating sparks of smaller sizes and lower brightness but laser radiation of higher pulse energy is used for creation of sparks of larger sizes and greater brightness.

Another embodiment of the invention comprises a method for producing sparks with shapes similar to spheres by focusing a laser radiation at the special geometric focal area. For example, short-focus lens creates sparks similar to ellipsoid and lens with shorter focal length creates ellipsoid sparks which are more similar to spheres.

Another embodiment of the invention comprises a method for producing sparks by crossing several laser beams so that the energy of each separate beam is lower than the breakdown threshold but their combined energy increases the breakdown threshold inside gases area of their intersection. Simultaneously, these separate beams can be focused at the intersection area.

One or more embodiments of the invention comprise a method for controlling spark shape and its duration by controlling temporal shapes of laser radiation. The control of spark duration is provided by the control of pulse duration: shorter pulse generates a sparks with shorter duration. The breakdown in gases has two general stages: (1) the production of the initial ionization, and (2) the subsequent cascade by which the ionization grows and a spark is observed. Therefore, it is reasonable to use specific laser pulse shape for controlling spark development so that at the beginning an applied laser radiation level just exceeds an energy threshold for creating an initial ionization condition in the medium, and thereafter the energy level of the applied laser radiation just maintains the subsequent cascade by which the ionization grows and a spark is observed. Simultaneously, such temporal shape of laser radiation provides formation of compact shape of the spark because of decreasing the velocity of initial expansion of the breakdown region toward the laser.

Another embodiment of the invention comprises a method for producing sparks with controlled shapes by controlling space structure of laser radiation. It is possible to create several separated small breakdown sparks inside the focal area of gaseous media by using special space structure of laser radiation. In this case integral brightness and shape of the spark is determined by the number of separated small sparks and their location at the breakdown area. Consequently, the control of the space structure of laser radiation provides generation breakdowns at different points of gaseous medium, which can be located so that to create compact shape of the integral spark.

Another embodiment of the invention comprises a method for producing sparks with compact shapes by using single mode laser radiation which provides focusing this radiation at the gaseous medium area of small sizes.

One or more embodiments of the invention comprise a method for controlling spark sizes by using laser radiation with wavelength which from one hand, provides focusing at smaller gaseous medium area, but from another hand, the gaseous medium is transparent for radiation with this wavelength. For example, the second harmonic of Nd-YAG laser is preferable to the first harmonic.

Another embodiment of the invention comprises a method for determining and controlling characteristics of gaseous medium inside of which sparks are generated in an optimal way. First, the gaseous medium should be transparent for used laser radiation. Second, it is desirable for the gaseous medium to have a low breakdown threshold value: a lower breakdown threshold permits to produce smaller sparks. The breakdown threshold can be reduced by adding to the used gaseous medium the very small impurities which do not practically change transparent characteristics of gases but which decrease breakdown threshold considerably. The use of special kinds of impurities gives a chance to change the spark spectrum, generating colored sparks. Creation of gases with specific characteristics can be produced both in air and in a special balloon. The cover of this balloon should be transparent for the used laser radiation but it can have different transparent characteristics for other waves. This permits to remove not desirable waves and to see color images.

Although each method disclosed above provides creation of breakdown sparks with improved characteristics a combination of these methods can be very effective for production of high quality LIDI.

One or more embodiments of the invention comprise a method for generation of breakdown sparks with controlled parameters inside gaseous medium, comprising:
control of brightness, shape, sizes and time existence of breakdown sparks by controlling characteristics of laser radiation;
control of spark parameters by controlling characteristics of gaseous medium;
generation of laser radiation with predetermined parameters;
focusing laser radiation at the gaseous medium for creation of energy density increasing the breakdown threshold corresponding to this gaseous medium.

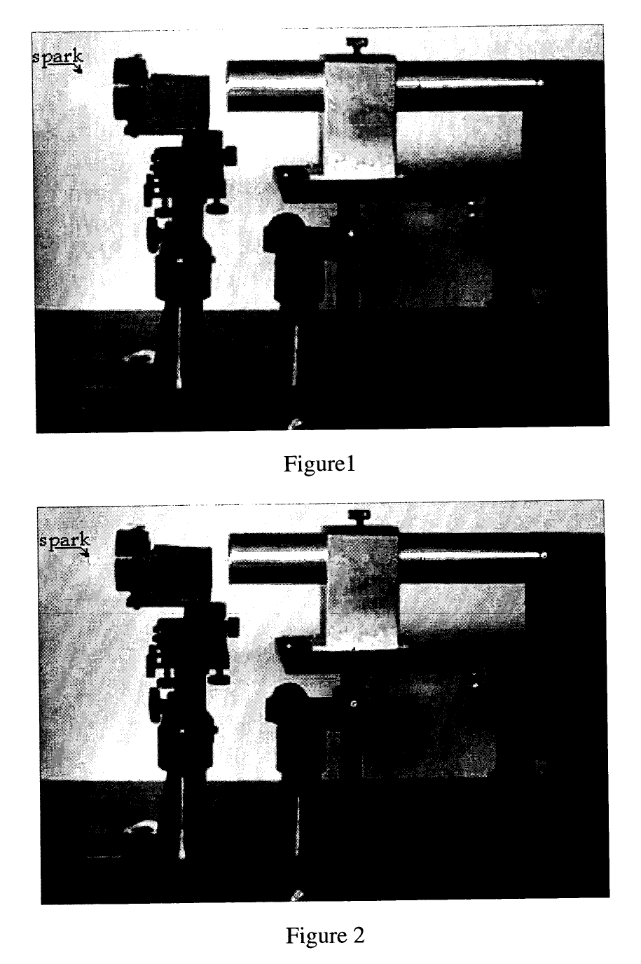

FIGS. 1 and 2 show photos of the air breakdown sparks produced by single mode second harmonic of Nd-YAG laser radiation focused by lens with short focal length (35 mm). These breakdown sparks have a form of spheres and their brightness and sizes can be controlled. The spark in FIG. 2 is produced by the pulse energy which is smaller than the pulse energy used for creation of the spark in FIG. 1.

One or more embodiments of the invention comprise a method wherein a laser-induced image inside gaseous medium is created as an arrangement of sparks which are generated inside gases by periodically focusing pulse laser radiation at the predetermined points so that the energy inside areas near the said points increases the breakdown threshold corresponding to the used gaseous medium.

Another embodiment of the invention comprises a method wherein a dynamic laser-induced image produced by a succession of breakdown sparks arrangements which replace one another.

Since laser-induced images inside gaseous medium are visible because breakdown sparks, the quality of these images depends on the light parameters of the sparks and their shapes and sizes. For example, for providing high space image resolution it is necessary to produce identical breakdown sparks of small sizes.

One or more embodiments of the invention comprise a method for producing dynamic laser-induced images inside gases, which includes the following steps:
Step 1: transformation of a dynamic image into sequence of stationary images creating the illusion of dynamics; transformation of each said stationary image into point arrangement that determines points of the gaseous medium at which the sparks are created for reproduction of this laser-induced image.
Step 2: determination of light parameters of the said sparks including their brightness, shapes, sizes, and image resolution for reproduction of the said image of needed quality.
Step 3: formation of gaseous medium, laser radiation and focal area for generation of said sparks with predetermined parameters by laser-induced breakdown phenomenon.
Step 4: generation of laser radiation with the predetermined parameters.
Step 5: focusing laser radiation at the said predetermined points of the gaseous medium.
Step 6: controlling laser radiation for production of dynamic laser-induce images.

The first procedure of the first step is transformation of a dynamic image into a sequence of stationary images which can create the illusion of dynamic (motion). Each image of this succession is transformed into arrangement of points at which the sparks should be created for reproduction of the laser-induced image. The transformation is produced, so that the distance between the adjacent sparks is not smaller than the half of the corresponding size. The number of points of a point arrangement determines the image space resolution and the gradation of brightness corresponds to the gray shades. The point arrangements can be created so that it is possible to reproduce several images with one enclosing the other, and sparks of each internal image are visible. In this case the distances between adjacent points are larger than corresponding sparks sizes and they are determined so that internal sparks are visible in the space between exterior sparks. The point arrangement can reproduce abstract images for production of light effects as fireworks, advertisements and so on.

Created point arrangement contains information both about location of the points inside gaseous medium and about gray shades (or color) of the reproduced image, therefore after this point arrangement has been created, it is necessary to determine light parameters of the breakdown sparks (including brightness and sizes), which should be generated at the points to reproduce needed image. The light parameters for predetermined sparks are founded by determination of brightness and sizes of breakdown sparks. The image resolution is founded by determination of shapes and sizes of the sparks.

Determination of needed image resolution and light parameters of the breakdown sparks provides information for formation of gaseous media, laser radiation and focal area for production of predetermined point arrangement. As a result of this step, the following general characteristics are determined: gases characteristics, temporal and space structure of laser radiation, pulse duration, wavelength, and pulse energy of the laser radiation, the number of laser beams and focal length of lens.

After generation of needed laser radiation, the next step is directing and focusing the laser radiation at the predetermined points of the gaseous medium so that dynamic laser-induced image can be created. The breakdown sparks of the point arrangements corresponding to each image of the image sequence, which has been created in the first step, are generated in order of their numeration in this succession. It is very important, that all breakdown sparks of the same point arrangement are created for the existing period of each stationary image. Duration of the spark is controlled by the duration of laser pulse and temporal characteristics of laser radiation and practically very shorter than eye inertia time. Therefore it is possible to generate all needed breakdown sparks for eye inertia time by using laser with corresponding high pulse repetition. Since duration of a breakdown spark is proportional to the pulse width, it is possible to generate very short and very small breakdown sparks which are not visible by the eye, but which can be fixed by special photosensitive apparatus. It opens the opportunities to generate dynamic images with very rapid changes. These images can be fixed by special apparatus and after can be investigated at the real time.

One or more embodiments of the invention comprise a method for producing very fast dynamic laser-induced images by generating breakdown sparks by ultra short laser pulses.

One of the most striking phenomena is the extinction of the laser light by the breakdown region. As a result, the generation of sparks at the predetermined points should be produced so that the sparks, which have already been generated, do not screen the points which are only waiting for sparks.

One or more embodiments of the invention comprise a motion image system for production of dynamic laser-induced images inside gaseous medium, comprising:
computer graphic system for transformation of an image into point arrangements of the gaseous medium at which the sparks should be created for reproduction of the laser-induced image;
control system for determination of light parameters of the breakdown sparks for reproduction of the said image of needed quality, for determination of laser radiation characteristics for production of predetermined breakdown sparks, and for control of production of dynamic laser-induced images;
gaseous medium system for creation and control of gaseous medium with needed characteristics;
laser system for generation of laser radiation with the predetermined parameters;
focusing system for directing and focusing laser radiation at the predetermined points of the gaseous medium.

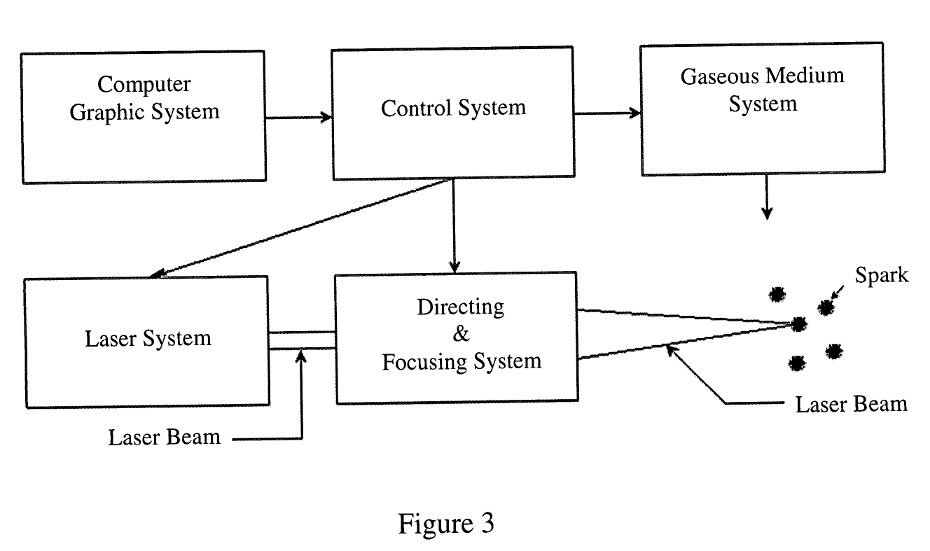

Reference is now made to FIG. 3, which illustrates in block-diagram form a system for production of dynamic laser-induced images inside gaseous medium. The system comprises computer graphic system, control system, means for creation of gaseous medium, laser system, and a system directing and focusing laser radiation.

Computer graphic system transforms a dynamic image into a succession of images which are not changed during the time equal to the eye inertia time, after which the system transforms each image of the said succession into corresponding arrangement of points at which the sparks are created for reproduction of the laser-induced image. The system forms the point arrangements, so that the distance between the adjacent sparks is not smaller than half of the corresponding size. In particular, the system is able to create such point arrangements, which reproduce several images enclosed in one another so that each image is visible. In this case the distances between adjacent points are larger than the corresponding sparks sizes and they are determined so that internal sparks are visible in the space between exterior sparks. Moreover, the system can form a point arrangement for production of light effects as fireworks, which are plurality of breakdown sparks inside air or another gaseous media.

Control system, taking into account needed quality of a laser-induced image, forms requirements for light parameters of the breakdown sparks (including brightness and sizes), which should be generated at the points of predetermined arrangements. Further, using this information, the system forms requirements for gaseous medium, temporal and space structure of laser radiation, pulse duration, wavelength, pulse energy, temporal and space structure of the laser radiation, the number of laser beams and focal length of lens. The system provides the control for directing laser radiation at the predetermined gaseous points with the necessary repetition of pulses for creation the dynamic laser-induced image.

Gaseous medium system creates the gaseous medium with needed characteristics and can control the characteristics during image production. The system provides the transparency of this area for used laser radiation and can create needed density of tiny impurities if they are desirable for decreasing breakdown threshold or for changing spectrum of generated sparks. Additionally, the system can create balloons with special cover for creating dynamic laser-induced images with specific characteristics inside these balloons.

Laser system generates laser radiation with the predetermined parameters. This laser radiation is periodically directed and focused at the predetermined points of the gaseous medium. The pulse repetition and the speed of directing laser radiation at the predetermined points are determined by the rapid of replacement of stationary images and number of sparks contained in these images. All commercial motion picture systems, including TV, use flicker rates in this region −48 or 72 Hz for films and 50 or 60 Hz for TV. Therefore, the pulse repetition of laser system should be about 50 kHz if each stationary laser-induced image contains about 1000 sparks.

I claim:

1. Method for generation of breakdown sparks with controlled parameters inside gaseous medium, comprising:
control of brightness, shape, sizes and time existence of breakdown sparks by controlling characteristics of laser radiation;
control of spark parameters by controlling characteristics of gaseous medium;
generation of laser radiation with predetermined parameters;
focusing laser radiation at the gaseous medium for creating energy density, which increases the breakdown threshold corresponding to this gaseous medium.

2. The method in accordance with claim 1 wherein brightness, shape, sizes and time existence of breakdown sparks are controlled by the pulse energy value, the number of modes (single or multimode), pulse width, wavelength, temporal shape and space structure of laser radiation.

3. The method in accordance with claim 1 wherein shape and sizes of breakdown sparks are controlled by the geometrical parameters of focal spot.

4. The method in accordance with claim 1 wherein the breakdown threshold and spectrum of sparks controlled by gaseous medium characteristics and the presence of special tiny impurities inside the medium.

5. The method in accordance with claim 1 wherein wavelength of laser radiation is determined so that the gaseous medium is transparent for this radiation.

6. The method in accordance with claim 1 wherein energy density, which increases the breakdown threshold inside a gaseous area, is created by intersection of several laser beams at the said area.

7. Method for producing dynamic laser-induced images inside gases, including:
transformation of a dynamic image into sequence of stationary images creating the illusion of dynamics and transformation of each said stationary image into point arrangement that determines points of the gaseous medium at which the sparks are created for reproduction of this laser-induced image;
determination of light parameters of the said sparks including their brightness, shapes, sizes, and image resolution for reproduction of the said image of needed quality;
formation of gaseous medium, laser radiation and focal area for generation of said sparks with predetermined parameters by using laser-induced breakdown phenomenon;
generation of laser radiation with the predetermined parameters;
focusing laser radiation at the said predetermined points of the gaseous medium;
controlling laser radiation for production of dynamic laser-induce images.

8. The method in accordance with claim 2 wherein a laser-induced image inside gaseous medium is created as an arrangement of sparks which are generated inside gases by periodically focusing pulse laser radiation at the predetermined points so that energy inside areas near the said points increases the breakdown threshold corresponding to the used gaseous medium.

9. The method in accordance with claim 2 wherein a dynamic laser-induced image produced by a succession of breakdown sparks arrangements which replace one with another.

10. The method in accordance with claim 2 wherein space resolution of laser-induced image is provided by corresponding number of breakdown sparks of the said image.

11. The method in accordance with claim 2 wherein the order of points in accordance to which the breakdowns are generated at the points of gaseous medium is determined so that the charged particles of previous breakdown do not absorb the laser radiation focused at the next point.

12. The method in accordance with claim 2 wherein laser-induced images are created inside special balloons which can contain gases with specific characteristics changing spectrum of sparks.

13. The method in accordance with claim 12 wherein the balloons can have special covers which change spectrum of breakdown sparks.

14. System for production of dynamic laser-induced images inside gaseous medium, comprising:
computer graphic system for transformation of an image into point arrangements of the gaseous medium at which the sparks are created for the reproduction of laser-induced image;
control system for determination and control of light parameters of the breakdown sparks for reproduction of the said image of needed quality, for determination and control of laser radiation characteristics for production of predetermined breakdown sparks, and for production control of a rapid sequence of stationary point arrangements corresponding to the dynamic laser-induced images;
gaseous medium system for creation and control of gaseous medium with needed characteristics;
laser system for generation of laser radiation with the predetermined parameters;
focusing system for directing and focusing laser radiation at the predetermined points of the gaseous medium.
